(19) United States
(12) Patent Application Publication
(10) Pub. No.: US 2014/0267696 A1
(43) Pub. Date: Sep. 18, 2014

(54) GLITCH-FREE DATA FUSION METHOD FOR COMBINING MULTIPLE ATTITUDE SOLUTIONS

(71) Applicant: NATIONAL APPLIED RESEARCH LABORATORIES (NARL), Taipei City (TW)

(72) Inventors: Ming-Yu YEH, Taipei City (TW); Ying-Wen JAN, Taipei City (TW); Chen-Tsung LIN, Taipei City (TW); Yeong-wei Andy WU, Taipei City (TW)

(73) Assignee: NATIONAL APPLIED RESEARCH LABORATORIES (NARL), Taipei City (TW)

(21) Appl. No.: 13/846,604

(22) Filed: Mar. 18, 2013

(51) Int. Cl. G01C 9/00

(52) U.S. Cl. CPC G01C 9/005
USPC 348/135

(57) ABSTRACT

A glitch-free data fusion method for combining multiple attitude solutions is disclosed, wherein a star camera is set as the master star camera. After acquiring attitude solutions from the star cameras, a rotation difference is calculated between a master attitude solution acquired from the master star camera and a slave attitude solution acquired from other star cameras. Then, a steady difference is acquired from the rotation difference via a low pass filter for correcting the slave attitude solution. When combining the corrected slave attitude solutions with the master attitude solution, the attitude glitches or attitude jumps, which occur while transitioning between data fusion configurations with different number of available attitude solutions, can be eliminated.

### BACKGROUND OF THE INVENTION

1. Field of the Invention

The present invention relates to a method for combining multiple attitude solutions, especially relates to a glitch-free data fusion method for combining multiple attitude solutions. The method provided by the present invention is for use with space satellites, more particularly, is used to eliminate the attitude glitch or attitude jump that occurs during the transition between data fusion configurations with different combinations of available attitude solutions.

2. The Prior Arts

In the field of aerospace, star cameras, or camera head units (CHUs), are usually used to estimate and to provide the attitude solutions of a spacecraft. In one specific application, multiple CHUs, mounted on a stable optical bench, are used to provide spacecraft inertia attitude knowledge with respect to a 3-axis reference frame defined by an optical instrument such as the high resolution Remote Sensing Instrument (RSI). The attitude data are usually provided in terms of quaternion. However, the attitude data provided by the multiple CHUs still need to be combined or fused in real time in order to be transformed into the optimized attitude solutions desired.

In order to do so, L. Roman has proposed a method called “Optimal combination of quaternion from multiple star cameras” in 2003, where a procedure for optimally combining attitude data measured simultaneously from different aligned star cameras was provided. In Roman's method, desired attitude solutions can be acquired via data fusion under both situations which attitude data from all three CHUs are available or attitude data from only two CHUs are available. Even though the orientation, which is the location, direction and angle of the CHU with respect to the spacecraft, of each CHU has been adjusted during the mounting process, the orientation from each CHU to the RSI reference frame can never be precisely known in the reality. In addition to the noises and biases generated from the method, the measurement errors regarding the orientation of each CHUs during the mounting process and the deformation which occurs in each CHUs due to the environmental factors in the outer space can both cause differences in the orientation. As a result, the attitude solutions provided by Romans exhibits bias in addition to the random noises or errors. The biases depend on the configurations of the CHU used during the operation, hence attitude jumps or attitude glitches will occur while transitioning from one configuration to another configurations, such as from three CHUs to two CHUs or vice versa.

In U.S. Pat. No. 7,124,001, the inventors disclosed a method for estimating the relative attitude between the slave payload attitude and the master payload attitude. The relative attitude estimated allows “slave channel” measurements to be corrected to be consistent with the “master channel” measurements and consequently used to improve the determination of the attitude of the master payload. Nevertheless, the combined attitude acquired in this method has not been optimized. In addition, the method disclosed did not provide a solution for the attitude jumps or attitude glitches, which occur during the transition between configurations with different number of available slave payload attitudes.

Therefore, a method, which can eliminate the biases while combining multiple attitude solutions, is yet to be provided. In addition, a method that can resolve the attitude jumps or attitude glitches, which occur during the transition between configurations with different number of CHUs available due to the measurement error or deformation caused by environment in the CHUs is yet to be provided as well.

### SUMMARY OF THE INVENTION

Due to the above reasons, a primary objective of the present invention is to provide a glitch-free data fusion method for combining multiple attitude solutions in the field of aerospace. The method provided by the present invention corrects the misalignment between the attitude data acquired from different star cameras or attitude sensors, so the attitude jumps or attitude glitches, which occur during the transition between configurations with different number of available CHUs or attitude sensors, can be eliminated.

In the glitch-free data fusion method provided by the present invention, a star camera is set as the master star camera. After acquiring attitude solutions from the star cameras, a rotation difference is calculated between a master attitude solution acquired from the master star camera and a slave attitude solution acquired from other star cameras. Then, a steady difference is acquired from the rotation difference via a low pass filter for correcting the slave attitude solution. When combining the corrected slave attitude solutions with the master attitude solution, the attitude glitches or attitude jumps, which occur while transitioning between data fusion configurations with different number of available attitude solutions, can be eliminated.

The glitch-free data fusion method includes the following steps: acquiring a plurality of attitude data from a plurality of corresponding star cameras or attitude sensors; setting one of the attitude data as a master attitude data, and setting the rest of the attitude data as a slave attitude data respectively; and correcting a misalignment between the slave attitude data and the master attitude data. The step of correcting a misalignment between the salve attitude data and the master attitude date further includes the following steps: calculating a rotation difference ΔQ between the slave attitude data and the master attitude data; acquiring a steady difference ΔQ_{f} from the rotation difference ΔQ via a low-pass filter; and correcting the slave attitude data with the steady difference ΔQf. After the misalignment is corrected, combine the corrected slave attitude data with the master attitude data.

The star cameras in the present invention can be a first camera head unit CHU1, a second camera head unit CHU2 and a third camera head unit CHU3. The first camera head unit CHU1 is set as the master camera head unit, and the master attitude data mentioned above is acquired from the master camera head unit. In addition, one of the two sets of attitude data used in the method of the present invention has to be the master attitude data Q₁ acquired from the master camera head unit, where the other attitude data can be the slave attitude data Q₂ or Q₃ acquired from the second camera head unit CHU2 or the third camera head unit CHU3.

Furthermore, each star camera have an orientation, and the misalignment being corrected in the present invention is a difference in the orientation of each star camera caused by the measurement error from the mounting process, or caused by the deformation in each star camera due to the environmental factors in the outer space.

The method described in the present invention is not limited to the three CHUs; it can also be extended to multiple CHUs or greater than three CHUs.

### BRIEF DESCRIPTION OF THE DRAWINGS

FIG. 1 is a flow chart showing the steps of the glitch-free data fusion method of the present invention;

FIG. 2 is a flow chart showing the detailed steps of step S11 according to the preferred embodiment of the present invention;

FIG. 3 is a flow chart showing the detailed steps of step S12 according to the preferred embodiment of the present invention;

FIG. 4 is a flow chart showing the detailed steps of combing multiple attitude solutions according to the preferred embodiment of the present invention;

FIG. 5 is a table showing the constant biases of two test cases of the three camera head unit in three directions;

FIG. 6 is a graph showing the total attitude error without the misalignment corrections of the glitch-free data fusion method based on the data from the first test case;

FIG. 7 is a graph showing the total attitude error with the misalignment corrections of the glitch-free data fusion method based on the data from the first test case;

FIG. 8 is a graph showing the total attitude error without the misalignment corrections of the glitch-free data fusion method based on the data from the second test case;

FIG. 9 is a graph showing the total attitude error with the misalignment corrections of the glitch-free data fusion method based on the data from the second test case; and

FIG. 10 is a flow chart showing a method for estimating the spacecraft inertia attitude.

### DETAILED DESCRIPTION OF THE PREFERRED EMBODIMENTS

The present invention will be apparent to those skilled in the art by reading the following detailed description of preferred embodiments thereof, with reference to the attached drawings.

FIG. 1 is the flow chart showing the steps of the glitch-free data fusion method of the present invention. As shown in FIG. 1, the glitch-free data fusion method for combining multiple attitude solutions of the present invention mainly includes three steps. First, in step S11, a plurality of attitude data is acquired from corresponding star cameras mounted on a spacecraft. Herein, the star cameras are the camera head units. Next, in step S12, the multiple attitude data acquired are corrected. Finally, in step S13, the corrected attitude data are combined. In the following paragraphs, each step will be described in details according to the preferred embodiment of the present invention.

FIG. 2 is a flow chart showing the detailed steps of step S11 according to the preferred embodiment of the present invention. As shown in FIG. 2, step S11 further includes three steps S111, S112 and S113. In the preferred embodiment of the present invention, the star cameras includes a first camera head unit CHU1, a second camera head unit CHU2 and a third camera head unit CHU3. The first camera head unit CHU1 is set as the master camera head unit, and is assumed as the camera head unit with the most precise attitude measurement with respect to the 3-axis reference frame, also known as the RSI frame, defined by an optical instrument such as the high resolution Remote Sensing Instrument (RSI). Under this premise, one of the multiple attitude data acquired in step S111 has to be a first attitude data, a quaternion representation Q₁, acquired from the master camera head unit CHU1. The rest of the attitude data can be a second or third attitude data, a quaternion representation Q₂ or Q₃ acquired from the second camera head unit CHU2 or the third camera head unit CHU3. Although the attitude data can be processed in any reference frames, the attitude data will be handled in the RSI frame in the preferred embodiment. Therefore, in step S112, the attitude data Q₁, Q₂ and Q₃ acquired are transformed into the RSI frame from each respective camera head unit frame.

Next, in step S113, the transformed first attitude data Q₁ acquired from the master camera head unit CHU1 is set as the master attitude data, and the transformed second and third attitude data Q₂ and Q₃ acquired from the second and third camera head unit CHU2 and CHU3 are set as the slave attitude data. Since the master camera head unit CHU1 is set as the camera head unit with the most precise measurement result, the misalignment correction in the following steps will be correcting the transformed slave attitude data Q₂ and Q₃ with respect to the transformed master attitude data Q₁.

In step S12, one set of the transformed slave attitude data is chosen first to proceed with the misalignment correction step. Hence, the misalignment correction between transformed slave attitude data Q₂ and the transformed master attitude data Q₁ is explained first.

Each of the star cameras has its own orientation. The misalignment being corrected in the present invention is the difference in the orientation caused by the measurement error during the mounting or caused by the deformation in each star camera due to environmental factors in the outer space. FIG. 3 is a flow chart showing the detailed steps of step S12 according to the preferred embodiment of the present invention. As shown in FIG. 3, the step of correcting the attitude data according to the preferred embodiment further includes three steps S121, S122 and S123. First, in step S121, a rotation difference ΔQ between the transformed master attitude data Q₁ and the transformed slave attitude data Q₂ is calculated. Next, in step S122, a low pass filter is used to obtain a steady difference ΔQ_{f} from the rotation difference ΔQ. The steady difference ΔQ_{f} obtained via the low pass filter has already excluded the noises caused by temperature, sun and the rotation of the spacecraft; therefore, the steady difference ΔQf obtained can be used to correct the transformed slave attitude data Q₂ directly in the next step S123.

Noteworthy, although the low pass filter is used in the preferred embodiment of the present invention to obtain the steady difference ΔQ_{f} from the rotation difference ΔQ, any other filters with the same function can also be used, and are also in the scope of the present invention.

FIG. 4 is a flow chart showing the detailed steps of combing multiple attitude solutions according to the preferred embodiment of the present invention. In the abovementioned steps, the slave attitude data Q₂ can be replaced with another slave attitude data Q₃ to obtain a corrected slave attitude data Q₃′ by repeating the same steps again. The corrected slave attitude data Q₂′ and Q₃′ obtained through steps S121, S122 and S123 can be used in step S13 to be fused with the transformed master attitude data Q₁ to obtain a complete inertia attitude solution of the spacecraft.

The data fusion method in step S13 in the preferred embodiment of the present invention is the “Optimal combination of quaternion from multiple star cameras” disclosed by L. Roman. The details of this method have already been described in the document provided by Roman and can be considered as the prior art in the field of knowledge; therefore, it will not be described here again in the present invention. In addition, the data fusion method by Roman is not the core part of the present invention.

FIG. 5 is a table showing the constant biases of two test cases of the three camera head unit in three directions. In order to verify the credibility of the glitch-free data fusion method provided by the present invention, the constant biases of the two test cases as shown in FIG. 5 will be used to run the method provided by the present invention. In the following paragraphs, total attitude error of the data fusion with misalignment correction and total attitude error of the data fusion without misalignment correction will be compared.

The total attitude error of the data fusion can be calculated with the following equation:

$$total attitude error = \sqrt{{( roll\_err )}^{2} + {( pitch\_err )}^{2} + {( yaw\_err * sin ( RSI\_FOV ) )}^{2}}$$

where roll err is the roll error, pitch_err is the pitch error, yaw_err is the yaw error and RSI_FOV is equal to 2 degrees.

FIG. 6 is a graph showing the total attitude error without the misalignment corrections of the glitch-free data fusion method based on the data from the first test case. FIG. 8 is a graph showing the total attitude error without the misalignment corrections of the glitch-free data fusion method based on the data from the second test case. During the operation of the spacecraft, the star cameras mounted thereon can be intruded by the light radiated from the sun or other planets, thereby losing its effect temporarily. Under such situations, the real time inertia attitude data fusion system will switch from the configuration which three attitude data are being fused to the configuration which two attitude data are being fused. During the transition process, attitude jumps or attitude glitches as shown in FIG. 6 and FIG. 8 will occur, and the main purpose of the present invention is to eliminate such glitches.

The glitch-free data fusion method according to the present invention is written into an algorithm in C++ language, so the misalignment correction of the transformed attitude data Q₁, Q₂ and Q₃ can be processed by computer programs in the preferred embodiment of the present invention. FIG. 7 is a graph showing the total attitude error with the misalignment corrections of the glitch-free data fusion method based on the data from the first test case. FIG. 9 is a graph showing the total attitude error with the misalignment corrections of the glitch-free data fusion method based on the data from the second test case. As shown in FIG. 7 and FIG. 9, when fusing the attitude data corrected by the method provided by the present invention, the attitude jumps or attitude glitches in the total attitude error does not appear as in FIG. 6 and FIG. 8. Therefore, based on the simulation results, it is known that the glitch-free data fusion method according to the present invention can eliminate the attitude jumps or attitude glitches when combining multiple attitude solutions.

FIG. 10 is a flow chart showing a method for estimating the spacecraft inertia attitude. The method shown in FIG. 10 is the gyro-stellar attitude determination 3 according to TW patent application number 97119874, where the attitude of the spacecraft can be determined based on the data provided by the gyros or the star cameras. As shown in FIG. 10, the glitch-free data fusion 210 is performed before the gyro-stellar attitude determination 3 and after the star camera heads 21 acquires the attitude data. In such way, the attitude data acquired from the star cameras is optimized and consequently is used to obtain a more precise attitude solution of the spacecraft.

In short, the glitch-free data fusion method provided by the present invention can calculate the misalignment value between any pair of camera head unit, and then apply the misalignment value into the attitude data in real time, so as to correct the misalignment in the attitude data before the attitude data are combined by the data fusion method disclosed by Roman. With the glitch-free data fusion method provided by the present invention, the attitude glitch can be eliminated when switching between data fusion configurations with different number of available attitude data.

The preferred embodiments described above are disclosed for illustrative purpose but to limit the modifications and variations of the present invention. Thus, any modifications and variations made without departing from the spirit and scope of the invention should still be covered by the scope of this invention as disclosed in the accompanying claims.

What is claimed is:

1. A glitch-free data fusion method for combining multiple attitude solutions, comprising:
acquiring a plurality of attitude data from a plurality of corresponding star cameras or other attitude sensors;
setting one of said attitude data as a master attitude data, and setting the rest of said attitude data as a slave attitude data respectively;
correcting a misalignment between said slave attitude data and said master attitude data; and
combining the corrected said slave attitude data with said master attitude data.

2. The glitch-free data fusion method as claimed in claim 1, wherein, correcting said misalignment between said slave attitude data and said master attitude data further comprises:
choosing one slave attitude data from said multiple slave attitude data.

3. The glitch-free data fusion method as claimed in claim 2, wherein, correcting said misalignment between said slave attitude data and said master attitude data further comprises:
calculating a rotation difference ΔQ between said slave attitude data and said master attitude data;
obtaining a steady difference ΔQf from said rotation difference ΔQ via a filter; and
correcting said slave attitude data with said steady difference ΔQ_{f}.

4. The glitch-free data fusion method as claimed in claim 3, wherein, said filter is a low pass filter.

5. The glitch-free data fusion method as claimed in claim 1, wherein, after acquiring said attitude data, transform said attitude data from camera head unit frame into a 3-axis reference frame defined by an optical instrument such as the high resolution Remote Sensing Instrument (RSI).

6. The glitch-free data fusion method as claimed in claim 1, wherein, said plurality of star cameras are a first camera head unit (CHU1), a second camera head unit (CHU2) and a third camera head unit (CHU3), wherein said first camera head unit (CHU1) is a master camera head unit.

7. The glitch-free data fusion method as claimed in claim 6, wherein, one of said acquired attitude data is a first attitude data (Q₁) acquired from said master camera head unit, and another said acquired attitude data is a second attitude data (Q₂) or a third attitude data (Q₃) acquired from said second camera head unit (CHU2) or said third camera head unit (CHU3).

8. The glitch-free data fusion method as claimed in claim 1, wherein, each of said plurality of star cameras has an orientation, and said misalignment is a difference in said orientation of each star camera.
